(19) United States
(12) Patent Application Publication
(10) Pub. No.: US 2010/0262927 A1
(43) Pub. Date: Oct. 14, 2010

(54) METHOD AND A DEVICE FOR CONTROLLING THE DISPLAY OF AN INFORMATION AREA ON THE WELCOME SCREEN OF A MOBILE TERMINAL

(75) Inventors: Tahar Mamouni, Villejuif (FR); Jean-Christophe Amiel, Arcueil (FR); Jérémie Lepreux, Meudon (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: FRANCE TELECOM, PARIS (FR)

(21) Appl. No.: 12/681,930

(22) PCT Filed: Nov. 10, 2008
(86) PCT No.: PCT/FR08/52025

§ 371 Date: May 19, 2010

(30) Foreign Application Priority Data
Nov. 15, 2007 (FR) 07 59078

(51) Int. Cl. G06F 3/048

(52) U.S. Cl. 715/764

(57) ABSTRACT

The invention relates to a method and a device for controlling the display of at least one information area on the welcome screen (3) of a mobile terminal (2). According to the invention, the priority for displaying data sent to the mobile terminal welcome screen application (6) and identified as relating to said information area is determined compared to data relating to an application likely to be running on the welcome screen, said information area is displayed in an available space on the welcome screen if the priority for displaying the data relating to said information area has been determined as higher than that for the data relating to the application running on the welcome screen.

### BACKGROUND OF THE INVENTION

The field of the invention is that of managing the welcome screens of mobile telecommunications terminals.

The invention relates more particularly to a method and a device for controlling the display of an information area on a mobile telecommunications terminal welcome screen.

The welcome screen of a mobile telecommunications terminal, in particular of a mobile telephone, is its main screen. Such a screen appears whenever the telephone is not executing a transaction or a function, such as a telephone conversation, or an application, for example sending an SMS message.

A mobile telephone welcome screen may in particular be personalized by the user by choosing a screen background image and shortcuts to specific applications and services offered by an operator and to which the user subscribes (weather, messaging, stock market, news, etc.).

There currently exist on personal computers (PC) applications that run as a background task and that provide quick access to the above-mentioned services. Such applications are better known as widgets. In practice, these widgets are shown on the welcome screen by icons representing the services to which the user subscribes. Such icons define information areas that are located in available spaces on the computer welcome screen. These widgets are stored beforehand in a dynamic memory of the computer and they are called up from a menu displayed on the screen.

For example, a user who subscribes to a weather service selects the widgets item in the welcome screen menu, and then the weather item. Following this operation, the weather widget is displayed on the computer's welcome screen, with the display area showing the weather widget containing information, for example the name of the town in which the user is located, a cloud if at the time of the user's enquiry the weather in the above-mentioned town is cloudy, the day, the date, and the temperature.

With a weather widget, some information that varies over time, for example the temperature, is necessarily downloaded into the computer from a dedicated server via a communications network after the user selects the weather widget.

With other widgets, all the data relating to the selected widget is stored locally in the computer. For example, if the user selects the music widget, an icon taking the form of a progress bar for the music currently being played is displayed in an available space on the welcome screen. This progress bar enables the user to execute certain actions such as pause, stop, play, next, etc.

Such widgets are not particularly suitable for display on mobile terminals, in particular mobile telephones, by reason mainly of the small size of their welcome screens.

### OBJECT AND SUMMARY OF THE INVENTION

To this end the present invention provides a method of controlling the display of at least one information area on the welcome screen of a mobile terminal, said method being characterized in that it includes:
a step of determining a priority for display of data sent to the welcome screen application of the mobile terminal and identified as relating to said information area compared to data relating to an application that may be running on the welcome screen; and
a step of displaying said information area in an available space on the welcome screen if the priority for displaying the data relating to said information area has been determined as being higher than that of the data relating to the application running on the welcome screen.

In a correlated way, the invention provides a device for controlling the display of an information area on the welcome screen of a mobile terminal, such a device being characterized in that it includes:
means for determining a priority for display of data sent to the welcome screen application of the mobile terminal and identified as relating to the information area compared to data relating to an application that may be running on the welcome screen; and
means for displaying the information area in an available space on the welcome screen if the priority for displaying the data relating to the information area has been determined as being higher than that of the data relating to the application running on the welcome screen.

Managing priorities in this way enables a widget to be displayed on the welcome screen of a mobile terminal without impeding the normal behavior of applications liable to be running on the welcome screen.

In one particular implementation of the invention, the data relating to the welcome screen and the data relating to the information area are contained in respective first and second files with the same format.

This provides an application installed in the mobile terminal with a simple way to send data and commands to the welcome screen application of the mobile terminal.

In one particular implementation of the invention, the steps of the control method are determined by computer program instructions.

Consequently, the invention also provides a computer program on an information medium, adapted to be executed in a display control device or more generally in a computer, and including instructions adapted to execute the steps of the above control method.

This program may use any programming language and take the form of source code, object code, or a code intermediate between source code and object code, such as a partially-compiled form, or any other desirable form.

The invention further provides a computer-readable information medium containing instructions of the above computer program.

The information medium may be any entity or device capable of storing the program. For example, the medium may include storage means, such as a ROM, for example a CD ROM or a micro-electronic circuit ROM, or magnetic storage means, for example a floppy disk or a hard disk.

Moreover, the information medium may be a transmissible medium such as an electrical or optical signal, suitable for being conveyed by an electrical or optical cable, by radio, or by other means. The program of the invention may in particular be downloaded over an Internet-type network.

Alternatively, the information medium may be an integrated circuit incorporating the program and adapted to execute the method in question or to be used in its execution.

### BRIEF DESCRIPTION OF THE DRAWINGS

Other features and advantages of the present invention emerge from the description given below with reference to the appended drawings, which show one non-limiting embodiment of the invention. In the figures:

FIG. 1 is a diagram of a mobile terminal that includes a display control device of the invention;

FIG. 2A shows a welcome screen on standby;

FIG. 2B shows a welcome screen showing that an application is being executed;

FIG. 2C shows a welcome screen displaying a widget; and

FIG. 3 is a flowchart of a display control method of the invention.

### DETAILED DESCRIPTION OF ONE EMBODIMENT OF THE INVENTION

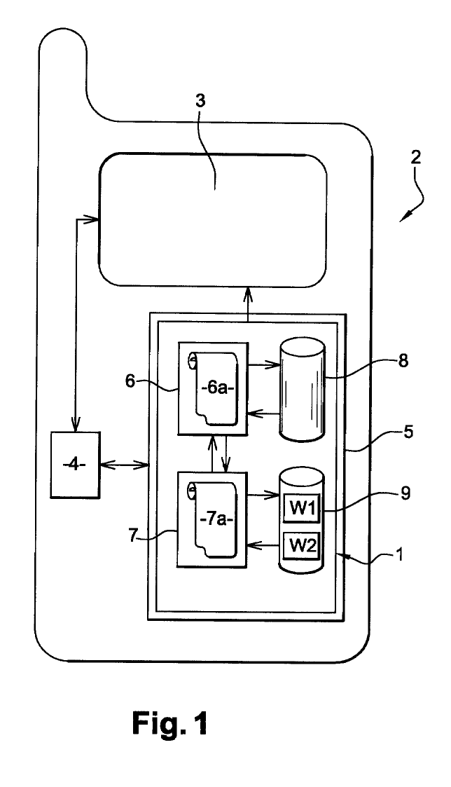

FIG. 1 shows a display control device 1 of the invention that is implemented in a mobile terminal 2.

In the example shown, the terminal 2 is a mobile telephone terminal that conventionally includes a display device 3, generally a liquid crystal display (LCD), on which a welcome screen is displayed when the terminal 2 is on standby as explained in the preamble to this description.

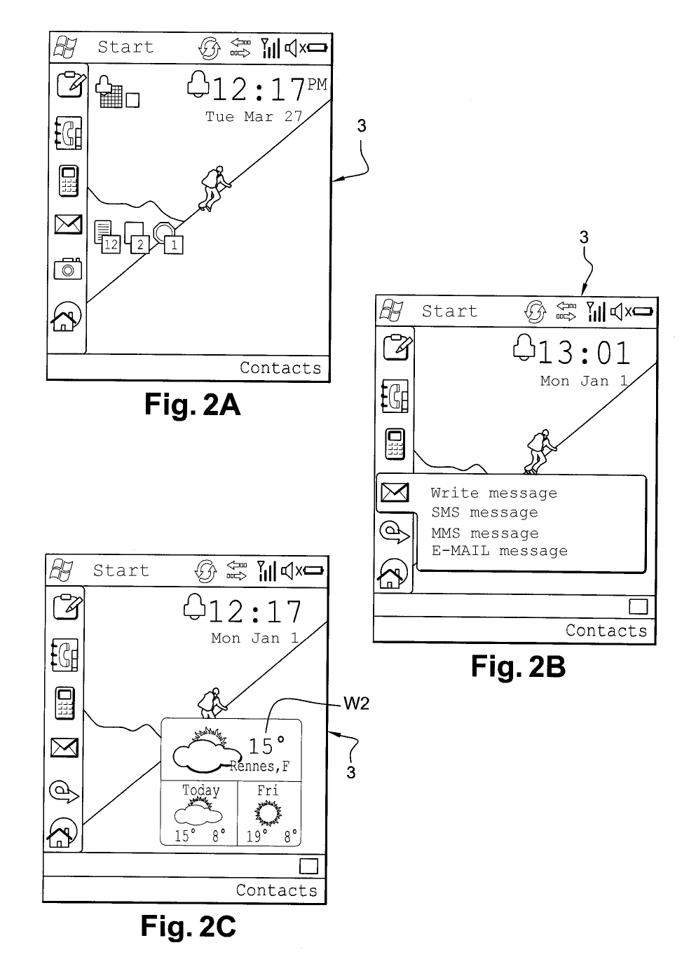

One type of standby welcome screen is shown in FIG. 2A, for example.

As shown in FIG. 1, and in a manner that is known in itself, the terminal 2 includes an operating system 4, for example of the mobile Windows type, and a memory 5 in which the display control device 1 is stored.

The display control device 1 more particularly includes:
a first application 6 for managing the welcome screen 3, intended to be executed by the operating system 4;
a second application 7 for managing widgets, also intended to be executed by the operating system 4.

The data relating to each application that can run on the welcome screen 3 (e.g. indication that a message has been received, entering a name into an address book, etc.) is stored in a directory 8. To be more precise, this data consists of information for displaying the welcome screen 3 and information for interacting with the user via the welcome screen 3, said data being used by the welcome screen management application 6.

If an application is running, for example if the user is reading messages, the welcome screen 3 notifies the execution of this application as shown in FIG. 2B.

In a manner that is particularly advantageous, the display data and the interaction data for each application that can run on the welcome screen 3 are grouped together in a binary language data file, in association with a specific identifier and in a particular format. To distinguish these data files from other files, such files are designated by a name followed by the extension “.tof”, for example.

For example, if n applications can run on the welcome screen 3, the respective n display and interaction data files corresponding to these n applications are assigned respective identifiers I1 to In, for example.

Referring again to FIG. 1, the widget management application 7 is for its part configured to consult a dynamic library 9 in which a list of available widgets is stored, for example two widgets W1 and W2. In a manner that is known in itself, such widgets are files, for example DLL (dynamic link library) files, stored in a dedicated directory containing at least three fields: a name, a descriptor, and an image.

The widgets W1 and W2 can be stored beforehand in the terminal 2, downloaded at the request of the user from a dedicated server, or created by a user who has the necessary computing knowledge.

More particularly, such widgets are written in the language C++ if the operating system 4 is of the mobile Windows type.

According to the invention, the above-mentioned widgets are advantageously programmed so as to contain (this list is not exhaustive):
data relating to the space that they are liable to occupy on the welcome screen 3;
data enabling the user to interact with this data when displayed on the welcome screen 3; and
data enabling the user to move the widgets on the welcome screen 3.

Interaction with the widget can be contextual, i.e. an action of the user on the widget can be linked to the current state of the widget. An example of such contextual interaction is given below.

Assume for example that the widget W1, which is entitled RSS News for example, is configured to display news streams, article by article, every n seconds. Such a widget advantageously has parameters set to enable the user, when a given article is displayed, to press a key configured to redirect the user to the complete article.

Such a key can be of the touch-sensitive or direct access (softkey) type.

The widget management application 7 is further configured so that after extracting a selected widget file from the dynamic library 9 at the request of the user it launches a sub-application 7a that retranscribes the extracted file into a data file in binary language, advantageously in the same “.tof” format as the above-mentioned display and interaction data files.

This provides the user with several simple ways to personalize the welcome screen 3, allowing widgets with very different contents and sizes to be displayed without having to recompile the welcome screen management application 6 each time.

The widget management application 7 then sends this “.tof” file to the welcome screen management application 6 as a series of blocks.

Each “.tof” file obtained by the sub-application 7a contains a specific identifier.

The respective two “.tof” files corresponding to the two widgets W1, W2 contained in the dynamic library 9 are assigned respective identifiers In+1 and In+2, for example.

This welcome screen management application 6 is further configured to launch a sub-application 6a able to read the identifier of the widget file sent, and to compare it to the identifier of a display and interaction data file relating to an application that could be running on the welcome screen 3.

In particular, if no application is running, the welcome screen management application 6 determines that the display of the sent widget file takes priority and proceeds to display the widget contained in said file in an available space, of parameters that are contained beforehand in said file.

Referring to FIG. 2C, the priority widget, for example the weather widget W2, is displayed on the welcome screen 3 bottom right.

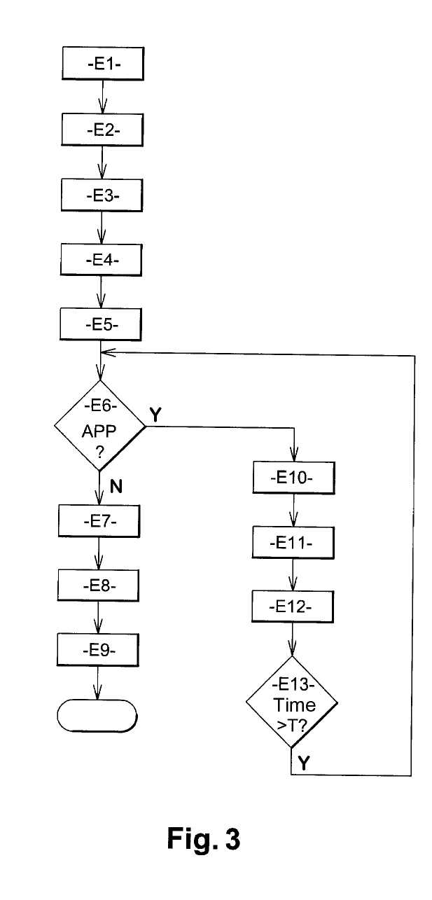

The operation of the device 1 for controlling the display of widgets on the welcome screen 3 of the terminal 2 is described below with reference to FIG. 3.

During a step E1, the user of the terminal 2 selects the weather widget W2 from a menu displayed on the welcome screen 3. The display of such menus is managed by the widget management application 7.

During a step E2, the widget management application 7 extracts the weather widget file from the dynamic library 9.

During a step E3, the widget management application 7 launches the sub-application 7a that retranscribes the weather widget file into a file with the TOF format associated with a specific identifier, for example In+2.

During a step E4, the widget management application 7 sends this TOF file to the welcome screen management application 6 as a series of blocks.

During a step E5, the welcome screen management application 6 launches the sub-application 6a that reads the identifier of the received TOF file.

During a step E6, the sub-application 6a dialogues with the application 6 to determine whether an application is running on the welcome screen 3.

If not, during a step E7, the sub-application 6a determines that displaying the weather widget takes priority.

During a step E8, the welcome screen management application 6 determines the space available on the welcome screen 3 for displaying the weather widget there, on the basis of information contained in the TOF form of the weather widget file.

When the available space has been determined, the welcome screen management application 6 proceeds during a step E9 to display the weather widget there.

If, during the step E6, an application is running on the welcome screen 3, for example if a text message is being sent, the welcome screen management application 6 reports to the sub-application 6a, during a step E10, that a TOF file corresponding to text message sending and having the identifier I1, for example, is running. During a step E11, the sub-application 6a compares the two identifiers I1 and In+2 and then, during a step E12, determines that sending the text message takes priority over displaying the weather widget.

During a step E13, the sub-application 6a launches a timer with a predetermined duration T so that when the duration has elapsed the sub-application 6a resumes the dialogue with the application 6, as in the above step E6, to determine whether the text message sending application is still running on the welcome screen 3 or whether some other application is running on the welcome screen 3.

The steps E10 to E13 are repeated for as long as there is an application running on the welcome screen 3.

If there is no longer any application running on the welcome screen 3, displaying the weather widget takes priority. The above-described steps E7 to E9 are then executed.

It goes without saying that the embodiment of the invention described above is given purely by way of illustrative and non-limiting example and that many modifications can easily be made to it by those skilled in the art without departing from the scope of the invention.

For example, the widget management application 7 could be configured to allow the display of more than one widget rather than only one widget, provided of course that the size of the widgets and the size of the welcome screen 3 of the terminal 2 make this possible.

1. A method of controlling the display of at least one information area on the welcome screen of a mobile terminal, said comprising the following steps:
a step of determining a priority for display of data sent to the welcome screen application of the mobile terminal and identified as relating to said information area compared to data relating to an application that may be running on the welcome screen; and
a step of displaying said information area in an available space on the welcome screen if the priority for displaying the data relating to said information area has been determined as being higher than that of the data relating to the application running on the welcome screen.

2. The method according to claim 1, wherein the data relating to the welcome screen and the data relating to said information area are contained in respective first and second files with the same format.

3. A device for controlling the display of at least one information area on the welcome screen of a mobile terminal, said device comprising the following means:
means for determining a priority order for display of data sent to the welcome screen application of the mobile terminal and identified as relating to said information area compared to data relating to an application that may be running on the welcome screen; and
means for displaying said information area in an available space on the welcome screen if the priority for displaying the data relating to said information area has been determined as being higher than that of the data relating to the application running on the welcome screen.

4. A mobile terminal comprising a welcome screen and a device according to claim 3 for controlling the display of at least one information area on the welcome screen.

5. A computer program comprising instructions for executing steps of the control method according to claim 1 when said program is executed by a computer.

6. A computer-readable storage medium on which is stored a computer program comprising instructions for executing the steps of the control method according to claim 1.
